(19) United States
(12) Patent Application Publication
(10) Pub. No.: US 2021/0304341 A1
(43) Pub. Date: Sep. 30, 2021

(54) PREVENTING DISCLOSURE OF SENSITIVE INFORMATION

(71) Applicant: International Business Machines Corporation, Armonk, NY (US)

(72) Inventors: Sophie D. Green, Andover (GB); Robert William John Parker, Romsey (GB); Stephen R.F. Head, Chandler's Ford (GB); Katherine Elizabeth Stanley, Hursley (GB)

(21) Appl. No.: 16/830,843

(22) Filed: Mar. 26, 2020

(51) Int. Cl. G06Q 50/26; G06Q 50/00; G06F 21/62; G06F 16/28

(52) U.S. Cl. CPC G06Q 50/265; G06F 16/285; G06F 21/6227; G06Q 50/01

(57) ABSTRACT

In an approach, a processor provides multiple defined categories of sensitive information. For each post associated with an entity, a processor extracts one or more information portions. A processor determines one or more categories to which each of the one or more information portions is relevant. A processor analyzes a category's respective information portions to combine the respective information portions determined to be relevant to the category to determine whether the combination of the respective information portions discloses sensitive information.

### BACKGROUND

The present invention relates to preventing disclosure of sensitive information and, more specifically, to preventing disclosure of sensitive information from multiple partial sources.

Many people have social media or other online accounts where they post information. These posts can include: text, location, and pictures, which may contain complete or incomplete personal or sensitive data, such as a location address, a telephone number, a car registration, etc.

Although it is typically possible to adjust privacy restrictions as to who can view information posted or otherwise included in such an account, and therefore possible to restrict who can see this data, many people leave their accounts open to the public. Furthermore, the information is available to the social media provider who may use this information for marketing or other purposes.

A person posting information may not be consciously aware of the combination of information that they are providing in a single account or over multiple accounts.

There are existing systems that will “determin[e] whether text within a post includes a pre-identified text pattern indicative of a first user's personal information, replacing any identified personal information with a number of trackback identifiers, and posting the text to the internet with the post including the number of trackback identifiers.” (Bastide et al., US Patent Application Publication No. 2013/0326020 A1). However, such systems do not take into account partial data that could be wholly revealed through viewing a set of multiple posts.

### SUMMARY

According to an aspect of the present invention there is provided a computer-implemented method for preventing disclosure of sensitive information. A processor provides multiple defined categories of sensitive information. For each post associated with an entity, a processor extracts one or more information portions. A processor determines one or more categories to which each of the one or more information portions is relevant. A processor analyzes a category's respective information portions to combine the respective information portions determined to be relevant to the category to determine whether the combination of the respective information portions discloses sensitive information. This provides the advantage of identifying portions of information posted using multiple posts and platforms over a period of time that together compromise sensitive information of an entity.

The method may include a processor that provides a storage system having a plurality of data buckets, each data bucket corresponding to a defined category in which information portions are stored for analysis. This provides the advantage of organizing data from a plurality of posts into a plurality of different categories so that partial information may be combined and potentially exposed sensitive information of an entity may be identified.

The method may include a processor that gathers information portions for populating the data buckets from a set of posts posted via one or more platform sources over a time period, the set of posts associated with the entity.

The method may include that determining whether the combination of the respective information portions discloses sensitive information may include a processor comparing the combination of the respective information portions to a set of criteria and a processor evaluating whether the combination of the respective information portions provides a complete set of data for the sensitive information.

A first post associated with an entity may be posted and the first post may include one or more of the group of: a text, an image, a video, and an audio clip. This provides the advantage of being able to compare different types of information and data formats, rather than only paying attention to a single data type.

Extracting the one or more information portions may include one or more of: text extraction, image recognition, image scraping, optical character recognition, sound to text processing, natural language processing, and metadata extraction. This provides the advantage of being able to compare different types of information and data formats, rather than only paying attention to a single data type.

In one embodiment, the method may include a processor accessing a storage system with categories of sensitive information storing information portions relevant to the respective categories. For each post associated with the entity, a processor extracts one or more information portions and determines one or more categories to which each information portion is relevant. A processor analyzes a category's respective information portions to determine if the respective information portions combine with existing information portions to create a combination that discloses sensitive information.

In a further embodiment, the method may include a processor accessing a storage system with categories of sensitive information storing information portions relevant to the respective categories. A processor analyzing a category's respective information portions to determine a missing information portion needed to combine with an existing information portions to create a combination that discloses sensitive information. For each additional post associated with the entity, a processor extracts one or more additional information portions and matches the one or more additional information portions to the missing information portion.

The method may include a processor monitoring posts for a missing information portion.

The method may include a processor providing a notification of disclosure of sensitive information disclosure.

The method may include a processor defining a new category of sensitive information based on a content of posts associated with the entity.

The method may further include a processor flagging posts for analysis based on analysis of each post's subject being relevant to potentially sensitive information.

According to another aspect of the present invention there is provided a computer-implemented method for preventing disclosure of sensitive information. A processor accesses a storage system with categories of sensitive information storing information portions relevant to each respective category. For each additional post associated with an entity, a processor extracts additional information portions and determines one or more categories to which the additional information portions are relevant. A processor analyzes a first category's information portions to determine whether the additional information portions associated with the first category combine with existing information portions to provide a combination that discloses sensitive information.

According to a further aspect of the present invention there is provided a system for preventing disclosure of sensitive information. One or more computer processors, one or more computer readable storage media, and program instructions collectively stored on the one or more computer readable storage media for execution by at least one of the one or more computer processors include program instructions to provide multiple defined categories of sensitive information. For each post associated with an entity, the system may include program instructions to extract one or more information portions. Further program instructions may determine one or more categories to which each of the one or more information portions is relevant. Further program instructions may analyze a category's respective information portions to combine the respective information portions determined to be relevant to the category to determine whether the combination of the respective information portions discloses sensitive information. This provides the advantage of identifying portions of information posted using multiple posts and platforms over a period of time that together compromise sensitive information of an entity.

The system may also include program instructions to provide a storage system having a plurality of data buckets, each data bucket corresponding to a defined category in which information portions are stored for analysis.

The system may also include program instructions to gather information portions for populating the data buckets from a set of posts posted via one or more platform sources over a time period, the set of posts associated with the entity.

The system may also include program instructions to compare the combination of the respective information portions to a set of criteria and program instructions to evaluate whether the combination of the respective information portions provides a complete set of data for the sensitive information.

The system may also include that a first post includes a text post, an image, a video, or an audio clip.

The system may also include that the extracting is text extraction, image recognition, image scraping, optical character recognition, sound to text processing, natural language processing, or metadata extraction.

The system may also include program instructions to access a storage system with categories of sensitive information storing information portions relevant to the respective categories. Additionally, program instructions to for each post associated with the entity, extract one or more information portions and determine one or more categories to which each information portion is relevant. Additionally, program instructions to analyze a category's respective information portions to determine if the respective information portions combine with existing information portions to create a combination that discloses sensitive information.

The system may also include program instructions to access a storage system with categories of sensitive information storing information portions relevant to the respective category. Additionally, program instructions to analyze a category's respective information portions to determine a missing information portion needed to combine with an existing information portion to create a combination that discloses sensitive information. Additionally, program instructions to for each additional post associated with the entity, extract one or more additional information portions and matching the one or more additional information portions to the missing information portion.

The system may also include program instructions to monitor posts for the missing information portion.

The system may also include program instructions to provide a notification of disclosure of the sensitive information to the entity.

The system may also include program instructions to define a new category of sensitive information based on content of posts associated with the entity.

According to a further aspect of the present invention there is provided a computer program product for preventing disclosure of sensitive information. One or more computer readable storage media, and program instructions collectively stored on the one or more computer readable storage media include program instructions to provide multiple defined categories of sensitive information. For each post associated with an entity, the system may include program instructions to extract one or more information portions. Further program instructions may determine one or more categories to which each of the one or more information portions is relevant. Further program instructions may analyze a category's respective information portions to combine the respective information portions determined to be relevant to the category to determine whether the combination of the respective information portions discloses sensitive information. This provides the advantage of identifying portions of information posted using multiple posts and platforms over a period of time that together compromise sensitive information of an entity.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Embodiments of the present invention will now be described, by way of example only, with reference to the following drawings in which:

FIG. 1 is a flow diagram of an example embodiment of a first aspect, in accordance with an embodiment of the present invention;

FIG. 2 is a flow diagram of an example embodiment of a second aspect, in accordance with an embodiment of the present invention;

FIG. 3 is a flow diagram of an example embodiment of a third aspect, in accordance with an embodiment of the present invention;

FIG. 4 is a schematic diagram, in accordance with an embodiment of the present invention;

FIG. 5 is a block diagram of an example embodiment of a system, in accordance with an embodiment of the present invention;

FIG. 6 is a block diagram of an embodiment of a computer system or cloud server in which the present invention may be implemented;

FIG. 7 depicts a cloud computing environment according to an embodiment of the present invention; and

FIG. 8 depicts abstraction model layers according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of the present invention describe and approach to prevent disclosure of sensitive information formed from the combination of a plurality of information portions that are disclosed in association with a target entity (e.g., user). The information portions may be disclosed across one or more platforms, such as social media platforms, by the target entity or by other parties associated with the target entity, such as connections on social media platforms.

The approach gathers, from multiple sources associated with the target entity, parts of personal or sensitive information that may be disclosed in profile information, posts, or otherwise accessible via the one or more platforms, such information is referred to as information portions. The information portions may be gathered from different platforms and at different times. The approach analyzes the information portions by categorizing them by the type of sensitive information to determine if sensitive information is being or is about to be disclosed by a combination of the information portions. For example, a first photograph of a user may include a house number. That information alone may not contain sensitive information, but when combined with a second photograph of the user that includes a street sign, embodiments of the present invention recognize that one may be able to combine the information to determine the location of the user.

Embodiments of the present invention recognize that users are concerned with personal privacy. Embodiments of the present invention may be provided as a service to users to help protect their personal information and prevent the accidental spread of their personal information. As embodiments of the present invention utilize extracted information from one or more platforms (e.g., social media platforms) associated with a user, the user may be presented with information explicitly describing what information may be gathered (e.g., types of information, sources of information) and may provide a user with an opt-in or opt-out option to tailor how their information will be collected and used. For example, a user may be able to restrict gathered information to only public posts from a particular social networking platform. In another example, a user may disable any collection of data.

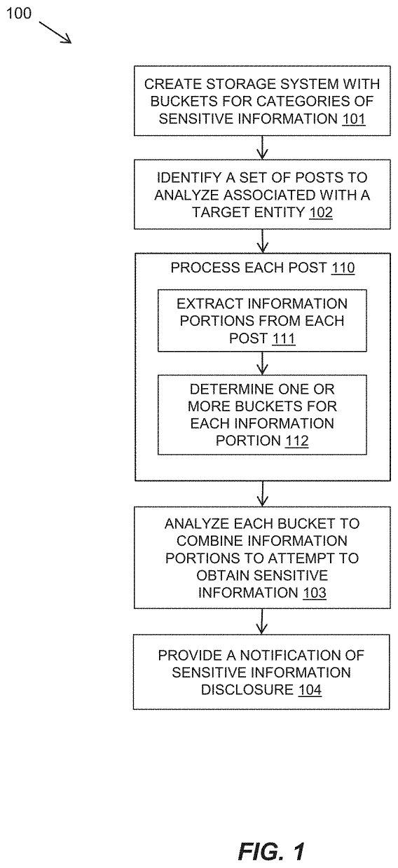

Referring to FIG. 1, a flow diagram 100 shows an example embodiment of an aspect of the described approach.

In step 101, sensitive information disclosure preventing system 420 creates a storage system with buckets for categories of types of sensitive data relating to a target entity. The buckets in the storage system may be data buffers or data structures for the different types of sensitive data. The types of sensitive data may be configured to include additional types of sensitive data as such types become evident. A target entity may be an individual or may be a group of individuals, such as a family or an organization. Types of sensitive data for a target entity in the form of an individual may include, for example, a personal address, a current location, a phone number, an identity number, a car registration plate, etc.

In step 102, sensitive information disclosure preventing system 420 identifies a set of posts associated with a target entity from which to gather information for analysis. The set of posts may be historical posts or posts in a defined time period relating to the target entity across one or more social media platforms for which the target entity has accounts. For example, for a social media account this may include all posts made by or about the target entity. The term “post” is defined as any media interaction relating associated with the target entity and including, as examples, text posts or comments by, tagging or referencing the target entity, images or videos taken by, including or referencing the target entity, etc. In some embodiments, the target entity selects criteria and/or filters as to what information should comprise the set of posts and from where to gather the information for analysis.

In step 110, sensitive information disclosure preventing system 420 processes each post by extracting information portions from each post (step 111) and determining one or more buckets for each information portion (step 112). When extracting information portions, sensitive information disclosure preventing system 420 may use a range of techniques to obtain information from posts including: text extraction, image recognition, image scraping, optical character recognition, sound to text processing, natural language processing, metadata extraction of posts, and analyzing headings of posts.

For text, sensitive information disclosure preventing system 420 may use natural language processing to identify key terms and determine whether the data is sensitive and the type of sensitive data. For example, sensitive information disclosure preventing system 420 may process the text to determine if the intent implies location, or if all or part of the text matches a pattern, for example, for an address.

For images, sensitive information disclosure preventing system 420 may use image recognition to identify objects within a post that link to a data type of sensitive data of a bucket. Existing image recognition technology is sufficiently sophisticated to determine, for example, that a door with a number indicates a location and therefore an address. Some social media platforms provide automatic image tagging that may be used to extract information.

For video content, sensitive information disclosure preventing system 420 may use speech to text capabilities to convert sound to text and sensitive information disclosure preventing system 420 analyzes the text using natural language processing, similarly to as described above. Sensitive information disclosure preventing system 420 may also analyze stills of video using image recognition, similarly to as described above.

In one example, a post may include text and a photo posted to a platform, such as a social network, by the target entity. Sensitive information disclosure preventing system 420 may process the text using natural language processing to have information portions extracted from the text that may be relevant to sensitive information, such as address portions, numbers that may be identity numbers or phone numbers, etc. Sensitive information disclosure preventing system 420 may analyze the image using image recognition to determine if the image includes portions (e.g., portions of the image) that may be relevant to sensitive information, such as text or images of locations or vehicles.

In step 112, sensitive information disclosure preventing system 420 may analyze extracted information portions to determine one or more categories of the type of sensitive information that the information portions may contribute to. For example, sensitive information disclosure preventing system 420 may add information portions that include numbers to a bucket for identity numbers and a bucket for telephone numbers. In another example, sensitive information disclosure preventing system 420 may add an image containing a car to a car registration bucket or an image of a door number to a bucket for addresses.

Sensitive information disclosure preventing system 420 may add the extracted data in the form of the information portions to the bucket(s) that the extracted data may correspond to. The specific data that has been used to determine the categorization may be stored in all possible buckets.

In step 103, sensitive information disclosure preventing system 420 may analyze each bucket in the storage system relating to a category of sensitive information to combine the information portions that have been added to each respective bucket in order to attempt to combine information and obtain sensitive information. For example, the address bucket may contain information portions for each of a door number, a road, and a town that, when combined by sensitive information disclosure preventing system 420, provide a full address.

Sensitive information disclosure preventing system 420 may use various methods to combine the information portions including: (i) combining like forms of information portions, such as multiple photo extracts, or (ii) combining different forms of information portions, such as a photo extract and a text extract.

Sensitive information disclosure preventing system 420 may use overlapping text to combine information portions where pattern matching is carried out to determine if a same set of letters is overlapped across multiple strings. For example, sensitive information disclosure preventing system 420 may combine two strings without repeating the overlapping letters to determine a valid piece of information.

Sensitive information disclosure preventing system 420 may determine if the combination of information from one or more buckets discloses sensitive information by comparing the combination to a set of criteria to evaluate if the combination provides a complete set of data for the sensitive information.

In step 104, sensitive information disclosure preventing system 420 provides a notification to alert the target entity if a bucket contains sufficient combined data to disclose sensitive information. In response to the notification, sensitive information disclosure preventing system 420 may prompt, or otherwise allow, the target entity to take action to delete one or more of the posts or to blur the key information. In some embodiments, sensitive information disclosure preventing system 420 actively prevents the uploading of the post, blurs the key information, and/or deletes one or more posts (e.g., the current post, a previous post that also includes key information relating to potentially sensitive information).

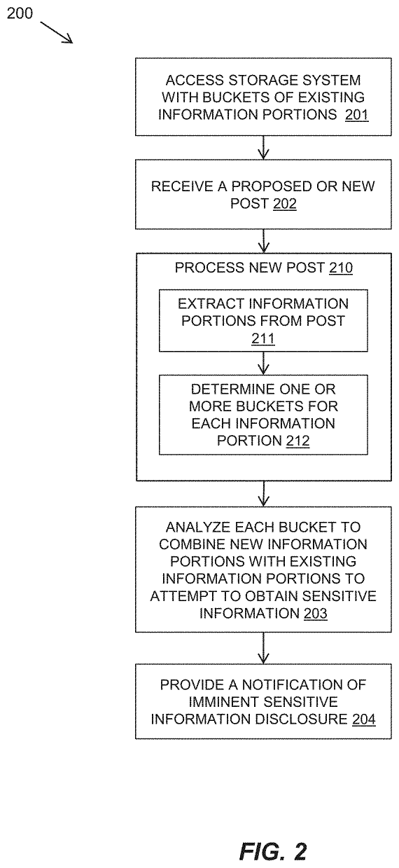

Referring to FIG. 2, a flow diagram 200 shows an example embodiment of a further aspect of the described approach.

In step 201, sensitive information disclosure preventing system 420 accesses a storage system of buckets of information portions for categories of types of sensitive data relating to a target entity, for example, as created and populated in the approach described in relation to FIG. 1, when an entity (e.g., user) is preparing to publish a new post.

In step 202, sensitive information disclosure preventing system 420 receives the new post, by a target entity or a posting entity (e.g., social network connection of the user), associated with a target entity for processing prior to the post being made. In one embodiment, sensitive information disclosure preventing system 420 or the respective platform may intercept the post and provide a check that occurs at the point of a user posting something, so that sensitive information disclosure preventing system 420 or the respective platform may suggest if the post potentially includes personal or sensitive information.

Sensitive information disclosure preventing system 420 may process posts to analyze the post's content. Sensitive information disclosure preventing system 420 may additionally highlight or flag posts if the content of a post is indicated, from the subject or the caption of the post, to be potentially related to something personal, for example, “My new home” or “I love driving my car.”

In step 210, sensitive information disclosure preventing system 420 processes the new post to extract new information portions from the post (step 211) and determine one or more buckets of the storage system relevant to each information portion (step 212). Sensitive information disclosure preventing system 420 may carry out the processing similarly to as described in step 110 of FIG. 1. The buckets of the storage system may already be populated with information portions from previous posts associated with the target entity.

In step 203, sensitive information disclosure preventing system 420 analyzes each bucket in which a new information portion is added to combine the new information portions with the existing information portions in the bucket to attempt to determine sensitive information. This may be similar to the analysis of step 103, as described with reference to FIG. 1.

In step 204, sensitive information disclosure preventing system 420 provides a notification, if a bucket contains sufficient combined data to disclose sensitive information, to alert the target entity and/or a posting entity (for example, if the posting entity creates a post that includes the target entity). Sensitive information disclosure preventing system 420 or the respective platform may prompt or otherwise allow the target entity or the posting entity may take action to abort the publishing of the proposed post or to blur the key information in the proposed post. In some embodiments, sensitive information disclosure preventing system 420 actively prevents the uploading of the post, blurs the key information, and/or deletes one or more posts (e.g., the current post, a previous post that also includes key information relating to potentially sensitive information).

In this way, sensitive information disclosure preventing system 420 notifies an entity when the entity is about to publish a post that, when combined with existing posts might risk sharing private or sensitive data.

Embodiments of the present invention describe an approach that may look for predefined sets of personal information, such as addresses, phone numbers and license plates. Additionally, the approach may be enhance abilities to develop or determine new relevant sets of personal information for which new buckets may be defined. Embodiments of the present invention may use machine learning to recognize new forms of sensitive information. For example, sensitive information disclosure preventing system 420 may notice that a user has posted that they are going on holiday, and sensitive information disclosure preventing system 420 may prompt the generation of a new bucket and the collection of various information portions that would give details about the holiday. This information may be used by sensitive information disclosure preventing system 420 to generate an alert to the user if any combination of posts could potentially include sensitive or private information.

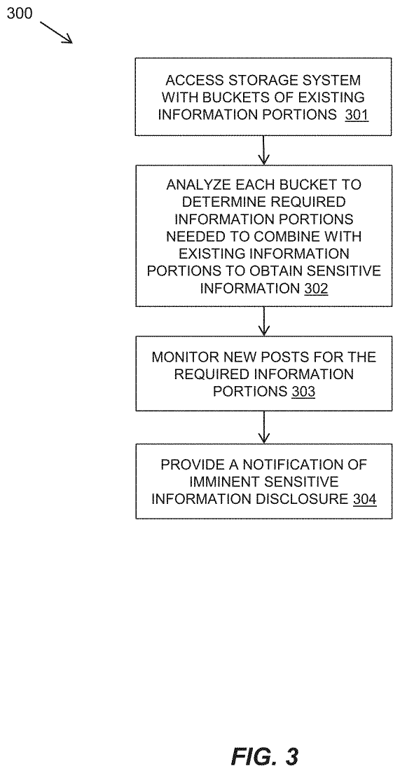

Referring to FIG. 3, a flow diagram 300 shows an example embodiment of a further aspect of the described approach, in accordance with an embodiment of the present invention.

In step 301, sensitive information disclosure preventing system 420 accesses a storage system of buckets of information portions for categories of types of sensitive data relating to a target entity, for example, as created and populated in the approach described in reference to FIG. 1. In step 302, sensitive information disclosure preventing system 420 further analyzes each bucket to identify additional information portions that would combine with existing information portions in the buckets to disclose sensitive information. Sensitive information disclosure preventing system 420 carries out the analysis for each bucket to determine required, missing information portions, that would combine with the existing information portions to complete a disclosure of sensitive information.

In step 303, sensitive information disclosure preventing system 420 may monitor new posts that are published, or intended for publication, to determine if the new posts include one of the identified required information portions. In step 304, if sensitive information disclosure preventing system 420 finds a post that includes such a required information portion, sensitive information disclosure preventing system 420 may provide a notification to alert the posting entity. Sensitive information disclosure preventing system 420 or the platform may prompt or otherwise allow the user take action to delete or abort the publishing of the post or to blur the key information within the post. In some embodiments, sensitive information disclosure preventing system 420 actively prevents the uploading of the post, blurs the key information, and/or deletes one or more posts (e.g., the current post, a previous post that also includes key information relating to potentially sensitive information).

If the buckets in the storage system already contain certain information about the target entity, for example, parts of the entity's address or phone number, sensitive information disclosure preventing system 420 may specifically monitor for the additional information needed to complete the address or phone number in new posts.

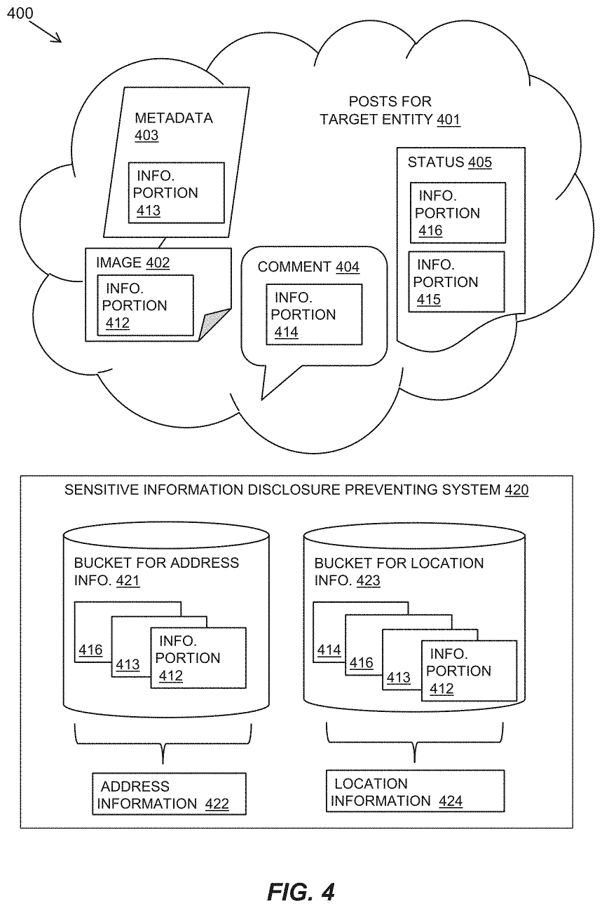

Referring to FIG. 4, a schematic diagram 400 illustrates an example of the described approach in accordance with an embodiment of the present invention. Posts 401 may be provided and are associated with a target entity across one or more social media platforms. Posts 401 may contain information that can be extracted, such as information portions 412-416 of sensitive information relating to the target entity.

As an example, a post may include an image 402 that includes an information portion 412 in the form of data shown in the image, such as a portion of a front door including a number. In addition, the image 402 may have metadata 403 published with image 402 that includes an information portion 413, such as geolocation data that may indicate a postcode, zip code, or town location. Another example may be a comment 404 provided by the target entity in relation to another entity's post and the comment 404 includes an information portion 414, such as a reference to “being away on holiday.” As another example, a post may be a status 405 by the target entity, or tagging the target entity, and including information portions 415 and 416, such as numerals of a telephone number or a text reference to a road of the target entity's address.

A sensitive information disclosure preventing system 420 is provided that gathers the information portions 412-416 from the posts 401 associated with a target entity and stores relevant information portions 412-416 in buckets 421 and 423 of a storage system that relate to different categories of sensitive information.

In this example, a bucket 421 may relate to address information and another bucket 423 may relate to entity location information. The address information bucket 421 may include: the information portion 412 of the image information of the target entity's front door, the information portion 413 of the target entity's postcode or zip code from the image metadata 403, and the information portion 416 of the reference to a road of the target entity's address from the status 405. The address information bucket 421 can be analyzed to obtain the full address information 422. In addition, a separate bucket 423 may be provided for a current location of the target entity that may also include the address information portions and additionally the information portion 414 of the reference in the comment 404 that the target entity is away on holiday, thereby providing the sensitive information of the location information 424 that the address is currently likely to be empty.

In another example, sensitive information disclosure preventing system 420 may determine, from geolocation metadata for multiple photos, where a target entity normally resides and may combines that information with text posts to determine the current location of the target entity.

In a further example use case, a user's social media account may already contain a post from a few months ago of the user posting a picture of their car, which shows the first half of their license plate, the remaining portion of the license plate blocked by the edge of the picture. On its own, this post does not contain a full license plate and therefore does not contain a complete item of personal information. The user then posts a new photo to another social media platform with their car in the background. For example, the person may be standing in front of the car and covering up the first half of their license plate with their person. Embodiments of the present invention recognize that the two photographs are of the same car and, when combined, provide the full license plate of the car. Sensitive information disclosure preventing system 420 alerts the user as to this prior to posting the new photo, and prompts or otherwise allows the user to decide whether they wish to cover up the number plate in the photo or not post the photo at all. In some embodiments, sensitive information disclosure preventing system 420 actively prevents the uploading of the photo, blurs the number plate, and/or deletes one or more posts (e.g., the current post, a previous post that also includes key information relating to potentially sensitive information).

As described, embodiments of the present invention have at least one advantage over existing art in that embodiments of the present invention look at multiple posts and machine learning may be used to identify further examples of personal information that the system does not know about from only looking at a single post, photograph, or similar item of information.

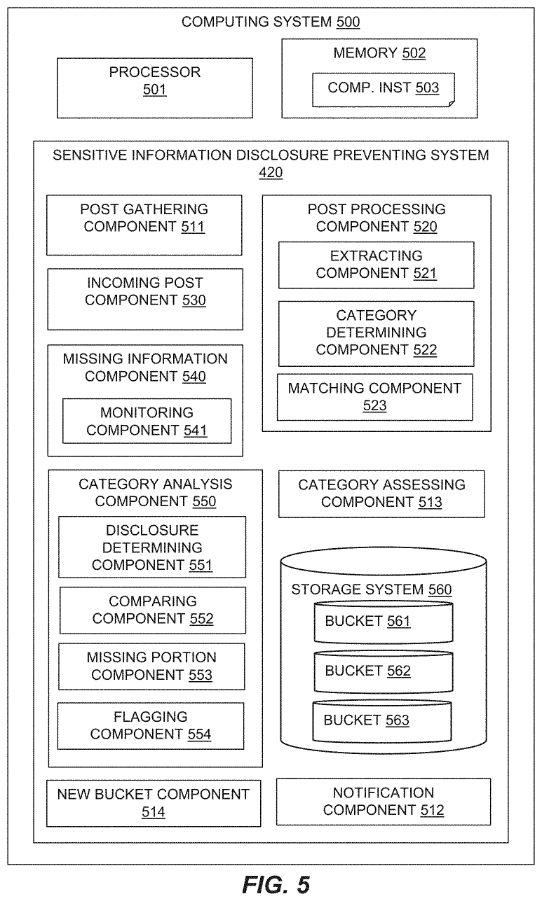

Referring to FIG. 5, a block diagram shows an example embodiment of a computing system 500 in which the described sensitive information disclosure preventing system 420 may be implemented. The computing system 500 may include at least one processor 501, a hardware module, or a circuit for executing the functions of the described components which may be software units executing on the at least one processor. Multiple processors running parallel processing threads may be provided enabling parallel processing of some or all of the functions of the components. Memory 502 may be configured to provide computer instructions 503 to the at least one processor 501 to carry out the functionality of the components.

As an example, the sensitive information disclosure preventing system 420 may be provided at an operating system level that has access to multiple accounts or applications in which a target entity posts or another posting entity posts associated with the target entity. As another example, the sensitive information disclosure preventing system 420 may be provided as an application that has access to other applications via which a target entity or a another posting entity may publish posts.

The sensitive information disclosure preventing system 420 includes, or has access to, a storage system 560 having defined categories of sensitive information for which data buckets 561-563 are provided in which information portions or references to the information portions are stored for analysis.

The sensitive information disclosure preventing system 420 may include a post gathering component 511 for gathering post information from multiple platforms for a target entity. The post gathering component 511 may gather a set of posts over a time period associated with the entity from one or more platform sources for initially populating the buckets 561-563 of the storage system 560.

The sensitive information disclosure preventing system 420 includes a post processing component 520, for processing each post associated with a target entity, and including an extracting component 521 for extracting one or more information portions. The extracting component 521 may include one or more of the processes of: text extraction, image recognition, image scraping, optical character recognition, sound to text processing, natural language processing, metadata extraction of posts, heading extraction of posts, geographical data extraction.

The post processing component 520 may include a category determining component 522 for determining one or more categories to which an information portion is relevant and for adding the extracted information portions into the relevant buckets 561-563.

A category analysis component 550 may be provided with access to the storage system 560 for analyzing a bucket's 561-563 information portions to combine the information portions determined to be relevant to the category to determine if the combination discloses sensitive information.

The category analysis component 550 may include a disclosure determining component 551 for determining if the combination discloses sensitive information by using a comparing component 552 for comparing the combination to a set of criteria to evaluate if the combination provides a complete set of data for the sensitive information.

The sensitive information disclosure preventing system 420 may include a notification component 512 for providing a notification of an existing or new sensitive information disclosure.

The sensitive information disclosure preventing system 420 may also include an incoming post component 530 for analyzing a new post that has just been published or is about to be published to identify potential disclosures of sensitive information.

The incoming post component 530 may use a category accessing component 513 for accessing the storage system 560 and the post processing component 520 may be used for processing each new or proposed post, including the extracting component 521 for extracting one or more new information portions and the category determining component 522 for determining one or more categories to which an information portion is relevant. The category analysis component 550 may analyzes a category's information portions to determine if the new information portions combine with existing information portions determined to provide a combination that discloses sensitive information and the notification component 512 may provide a notification of potential sensitive information disclosure.

The sensitive information disclosure preventing system 420 may also include a missing information component 540 including a monitoring component 541 for monitoring new or proposed posts for missing information portions that may combine with existing posts to disclosure sensitive information.

The missing information component 540 may use a category accessing component 513 for accessing the storage system 560 and the category analysis component 550 includes a missing portion component 553 for analyzing a category's information portions to determine a missing information portion needed to combine with the existing information portions to provide a combination that discloses sensitive information. The post processing component 520 may be used for each new or proposed post associated with an entity, including the extracting component 521 extracting one or more new information portions and a matching component 523 for matching the one or more new information portions to the missing information portion for a category. The notification component 512 may provide a notification of potential sensitive information disclosure.

The category analysis component 550 may include a flagging component 554 for flagging posts for analysis based on analysis of their subject or caption being relevant to potentially sensitive information.

The sensitive information disclosure preventing system 420 may further include a new bucket component 514 for determining a new relevant category of sensitive information for which a new bucket is required to be defined.

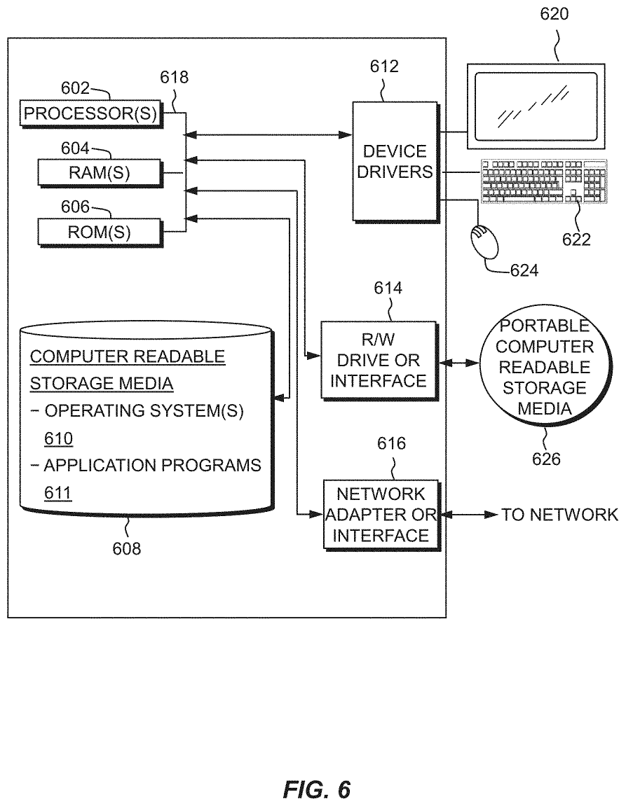

FIG. 6 depicts a block diagram of components of the computing system 500 of FIG. 5, in accordance with an embodiment of the present invention. It should be appreciated that FIG. 5 provides only an illustration of one implementation and does not imply any limitations with regard to the environments in which different embodiments may be implemented. Many modifications to the depicted environment may be made.

Computing system 500 can include one or more processors 602, one or more computer-readable RAMs 604, one or more computer-readable ROMs 606, one or more computer readable storage media 608, device drivers 612, read/write drive or interface 614, and network adapter or interface 616, all interconnected over a communications fabric 618. Communications fabric 618 can be implemented with any architecture designed for passing data and/or control information between processors (such as microprocessors, communications and network processors, etc.), system memory, peripheral devices, and any other hardware components within the system.

One or more operating systems 610, and application programs 611, such as the sensitive information disclosure preventing system 420, are stored on one or more of the computer readable storage media 608 for execution by one or more of the processors 602 via one or more of the respective RAMs 604 (which typically include cache memory). In the illustrated embodiment, each of the computer readable storage media 608 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

Computing system 500 can also include a R/W drive or interface 614 to read from and write to one or more portable computer readable storage media 626. Application programs 611 on computing system 500 can be stored on one or more of the portable computer readable storage media 626, read via the respective R/W drive or interface 614 and loaded into the respective computer readable storage media 608.

Computing system 500 can also include a network adapter or interface 616, such as a TCP/IP adapter card or wireless communication adapter. Application programs 611 on computing system 500 can be downloaded to the computing device from an external computer or external storage device via a network (for example, the Internet, a local area network or other wide area networks or wireless networks) and network adapter or interface 616. From the network adapter or interface 616, the programs may be loaded into the computer readable storage media 608. The network may comprise copper wires, optical fibers, wireless transmission, routers, firewalls, switches, gateway computers and edge servers.

Computing system 500 can also include a display screen 620, a keyboard or keypad 622, and a computer mouse or touchpad 624. Device drivers 612 interface to display screen 620 for imaging, to keyboard or keypad 622, to computer mouse or touchpad 624, and/or to display screen 620 for pressure sensing of alphanumeric character entry and user selections. The device drivers 612, R/W drive or interface 614, and network adapter or interface 616 can comprise hardware and software stored in computer readable storage media 608 and/or ROM 606.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

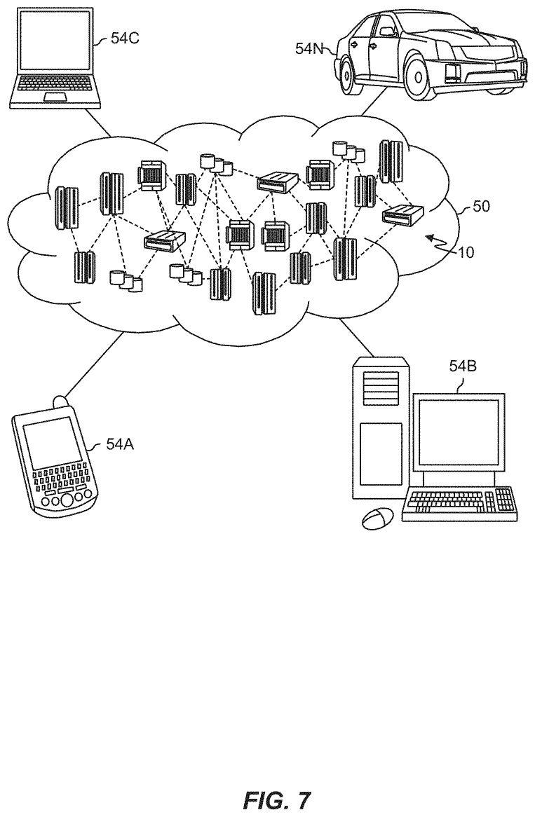

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

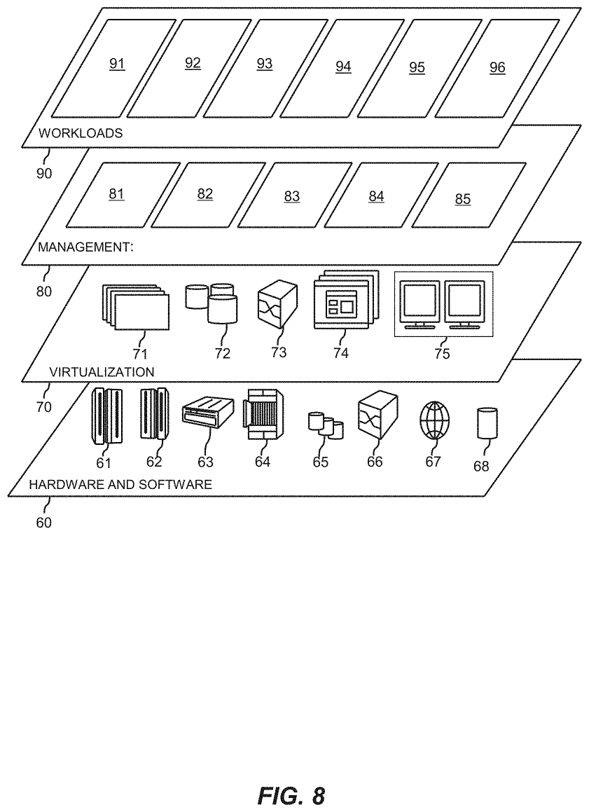

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and sensitive information processing 96.

A computer program product of the present invention comprises one or more computer readable hardware storage devices having computer readable program code stored therein, said program code executable by one or more processors to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for preventing disclosure of sensitive information, comprising:
providing, by one or more processors, multiple defined categories of sensitive information;
for each post associated with an entity, extracting, by one or more processors, one or more information portions;
determining, by one or more processors, one or more categories to which each of the one or more information portions is relevant; and
analyzing, by one or more processors, a category's respective information portions to combine the respective information portions determined to be relevant to the category to determine whether the combination of the respective information portions discloses sensitive information.

2. The method of claim 1, further comprising:
providing, by one or more processors, a storage system having a plurality of data buckets, each data bucket corresponding to a defined category in which information portions are stored for analysis.

3. The method of claim 2, further comprising:
gathering, by one or more processors, information portions for populating the data buckets from a set of posts posted via one or more platform sources over a time period, the set of posts associated with the entity.

4. The method of claim 1, wherein determining whether the combination of the respective information portions discloses sensitive information comprises:
comparing, by one or more processors, the combination of the respective information portions to a set of criteria; and
evaluating, by one or more processors, whether the combination of the respective information portions provides a complete set of data for the sensitive information.

5. The method of claim 1, wherein a first post associated with the entity is posted and the first post includes a selection from the group consisting of: a text post, an image, a video, and an audio clip.

6. The method of claim 1, wherein extracting the one or more information portions comprises a selection from the group consisting of: text extraction, image recognition, image scraping, optical character recognition, sound to text processing, natural language processing, and metadata extraction.

7. The method of claim 1, further comprising:
accessing, by one or more processors, a storage system with categories of sensitive information storing information portions relevant to the respective categories;
for each post associated with the entity, extracting, by one or more processors, one or more additional information portions and determining, by one or more processors, one or more categories to which each additional information portion is relevant; and
analyzing, by one or more processors, the category's respective information portions to determine if the respective additional information portions combine with existing information portions to create a combination that discloses sensitive information.

8. The method of claim 1, further comprising:
accessing, by one or more processors, a storage system with categories of sensitive information storing information portions relevant to the respective category;
analyzing, by one or more processors, the category's respective information portions to determine a missing information portion needed to combine with an existing information portion to create a combination that discloses sensitive information; and
for each additional post associated with the entity, extracting, by one or more processors, one or more additional information portions and matching the one or more additional information portions to the missing information portion.

9. The method of claim 8, further comprising:
monitoring, by one or more processors, posts for the missing information portion.

10. The method of claim 1, further comprising:
providing, by one or more processors, a notification of disclosure of the sensitive information to the entity.

11. The method of claim 1, further comprising:
defining, by one or more processors, a new category of sensitive information based on content of posts associated with the entity.

12. The method of claim 1, further comprising:
flagging, by one or more processors, posts for analysis based on analysis of each post's subject being relevant to potentially sensitive information.

13. A computer-implemented method for preventing disclosure of sensitive information, comprising:
accessing, by one or more processors, a storage system, with categories of sensitive information, storing information portions relevant to each respective category;
for each additional post associated with an entity, extracting, by one or more processors, additional information portions and determining one or more categories to which the additional information portions are relevant; and
analyzing, by one or more processors, a first category's information portions to determine whether the additional information portions associated with the first category combine with existing information portions to provide a combination that discloses sensitive information.

14. A computer system for preventing disclosure of sensitive information, comprising:
one or more computer processors, one or more computer readable storage media, and program instructions collectively stored on the one or more computer readable storage media for execution by at least one of the one or more computer processors, the program instructions comprising:
program instructions to provide multiple defined categories of sensitive information;
program instructions to, for each post associated with an entity, extract one or more information portions;
program instructions to determine one or more categories to which each of the one or more information portions is relevant; and
program instructions to analyze a category's respective information portions to combine the respective information portions determined to be relevant to the category to determine whether the combination of the respective information portions discloses sensitive information.

15. The computer system of claim 14, further comprising:
program instructions, collectively stored on the one or more computer readable storage media for execution by at least one of the one or more computer processors, to provide a storage system having a plurality of data buckets, each data bucket corresponding to a defined category in which information portions are stored for analysis.

16. The computer system of claim 15, further comprising:
program instructions, collectively stored on the one or more computer readable storage media for execution by at least one of the one or more computer processors, to gather information portions for populating the data buckets from a set of posts posted via one or more platform sources over a time period, the set of posts associated with the entity.

17. The computer system of claim 14, wherein program instructions to determine whether the combination of the respective information portions discloses sensitive information comprise:
program instructions to compare the combination of the respective information portions to a set of criteria; and
program instructions to evaluate whether the combination of the respective information portions provides a complete set of data for the sensitive information.

18. The computer system of claim 14, wherein a first post associated with the entity is posted and the first post includes a selection from the group consisting of: a text post, an image, a video, and an audio clip.

19. The computer system of claim 14, wherein extracting the one or more information portions comprises a selection from the group consisting of: text extraction, image recognition, image scraping, optical character recognition, sound to text processing, natural language processing, and metadata extraction.

20. The computer system of claim 14, further comprising:
program instructions, collectively stored on the one or more computer readable storage media for execution by at least one of the one or more computer processors, to access a storage system with categories of sensitive information storing information portions relevant to the respective categories;
program instructions, collectively stored on the one or more computer readable storage media for execution by at least one of the one or more computer processors, to, for each post associated with the entity, extract one or more information portions and determine one or more categories to which each information portion is relevant; and
program instructions, collectively stored on the one or more computer readable storage media for execution by at least one of the one or more computer processors, to analyze a category's respective information portions to determine if the respective information portions combine with existing information portions to create a combination that discloses sensitive information.

21. The computer system of claim 14, further comprising:
program instructions, collectively stored on the one or more computer readable storage media for execution by at least one of the one or more computer processors, to access a storage system with categories of sensitive information storing information portions relevant to the respective category;
program instructions, collectively stored on the one or more computer readable storage media for execution by at least one of the one or more computer processors, to analyze a category's respective information portions to determine a missing information portion needed to combine with an existing information portion to create a combination that discloses sensitive information; and
program instructions, collectively stored on the one or more computer readable storage media for execution by at least one of the one or more computer processors, to, for each additional post associated with the entity, extract one or more additional information portions and matching the one or more additional information portions to the missing information portion.

22. The computer system of claim 21, further comprising:
program instructions, collectively stored on the one or more computer readable storage media for execution by at least one of the one or more computer processors, to monitor posts for the missing information portion.

23. The computer system of claim 14, further comprising:
program instructions, collectively stored on the one or more computer readable storage media for execution by at least one of the one or more computer processors, to provide a notification of disclosure of the sensitive information to the entity.

24. The computer system of claim 14, further comprising:
program instructions, collectively stored on the one or more computer readable storage media for execution by at least one of the one or more computer processors, to define a new category of sensitive information based on content of posts associated with the entity.

25. A computer program product for preventing disclosure of sensitive information, comprising:
one or more computer readable storage media, and program instructions collectively stored on the one or more computer readable storage media, the program instructions comprising:
program instructions to provide multiple defined categories of sensitive information;
program instructions to, for each post associated with an entity, extract one or more information portions;
program instructions to determine one or more categories to which each of the one or more information portions is relevant; and
program instructions to analyze a category's respective information portions to combine the respective information portions determined to be relevant to the category to determine whether the combination of the respective information portions discloses sensitive information.
